(19) United States
(12) Patent Application Publication
(10) Pub. No.: US 2016/0104255 A1
(43) Pub. Date: Apr. 14, 2016

(54) System, Method and Apparatus for Using Points in an Online Marketplace

(71) Applicant: Victor Kulish, San Diego, CA (US)

(72) Inventor: Victor Kulish, San Diego, CA (US)

(21) Appl. No.: 14/977,620

(22) Filed: Dec. 21, 2015

Related U.S. Application Data
(63) Continuation-in-part of application No. 14/210,631, filed on Mar. 14, 2014.

(51) Int. Cl. G06Q 50/00; G06Q 30/02

(52) U.S. Cl. CPC G06Q 50/01; G06Q 30/0231

(57) ABSTRACT

System, method, and apparatus are provide for using points in an online marketplace. The invention provides for storing, by at least one processor, a user's history of past transactions as sharing points and borrowing points, providing a user interface for users to create an online transaction with an established point value for the transaction, wherein the transaction involves a user sharing an item or service and another user receiving an item or service, adding the transaction point value to a borrowing or receiving user's borrowing points total, and calculating a point value and adding it to a sharing or providing user's sharing points total.

### CROSS REFERENCE TO RELATED APPLICATIONS

This application claims priority from a non-provisional U.S. patent application Ser. No. 14/210,631 filed on Mar. 14, 2014.

### FIELD OF THE INVENTION

Embodiments of the invention generally relate to social networking and online marketplace websites and applications. Specifically, embodiments of the invention relate to using points in an online marketplace.

### BACKGROUND OF THE INVENTION

Social networking, auction and classified listing websites and applications bring users together to connect and interact. Many users would normally not have access to each other without such websites. It can allow them to participate in an online marketplace, usually involving monetary transactions. There are other websites and applications that create a communal society in which members share and barter with each other, in which no money is involved to motivate participation. Users receive great benefits from interacting with each other, borrowing from each other, and receiving help from volunteers. However, users must rely on a willingness to participate or the charitable nature of individuals to share and volunteer.

### SUMMARY

Without a form of currency, a social network or online marketplace can provide a point system to incentivize users to participate in transactions and other interactions. In accordance with the teachings of the present invention, a method and system that uses points in an online transaction between users in a social network or marketplace is provided.

In accordance with the teachings of the present invention, system, method, and apparatus for using points in an online marketplace, is provided. The invention provides for storing, by at least one processor, a user's history of past transactions as sharing points and borrowing points, providing a user interface for users to create an online transaction with an established point value for the transaction, wherein the transaction involves a user sharing an item or service and another user receiving an item or service, adding the transaction point value to a borrowing or receiving user's borrowing points total, and calculating a point value and adding it to a sharing or providing user's sharing points total. Additionally, the borrowing user's sharing points to borrowing points ratio can be used to calculate the point value to be added to the sharing user's sharing points total. This can be done directly by multiplying the transaction point value and the borrowing user's sharing points to borrowing points ratio. It can also be done indirectly by translating the borrowing user's sharing points to borrowing points ratio into a point multiplier and then multiplying the transaction point value and the point multiplier.

Such a system comprises a database storing a user's history of past transactions as sharing points and borrowing points, a means for establish a point value for a transaction, and a processor that subtracts the transaction point value from a borrowing or receiving user's participation points total and calculates and adds a point value to a sharing or providing user's participation points total.

### BRIEF DESCRIPTION OF THE DRAWINGS

The accompanying drawings taken in conjunction with the detailed description will assist in making the advantages and aspects of the disclosure more apparent.

FIG. 1 is a block diagram of a general system embodiment.

FIG. 2 is a flow chart showing how points are awarded from a user interaction in a preferred embodiment.

FIG. 3 is the database schema of a preferred embodiment.

### DETAILED DESCRIPTION

Reference will now be made in detail to the present embodiments discussed herein, illustrated in the accompanying drawing. The embodiments are described below to explain the disclosed system, method and apparatus by referring to the figures using like numerals. It will be nevertheless be understood that no limitation of the scope is thereby intended, such alterations and further modifications, and such further applications of the principles as illustrated therein being contemplated as would normally occur to one skilled in the art to which the embodiments relate.

The subject matter is presented in the general context of systems and program modules. Those skilled in the art will recognize that other implementations may be performed that may include different data structures, components, or routines that perform similar tasks. The invention can be practiced using various computer system configurations, such as client server systems.

System, method and apparatus for using points in an online community marketplace are provided.

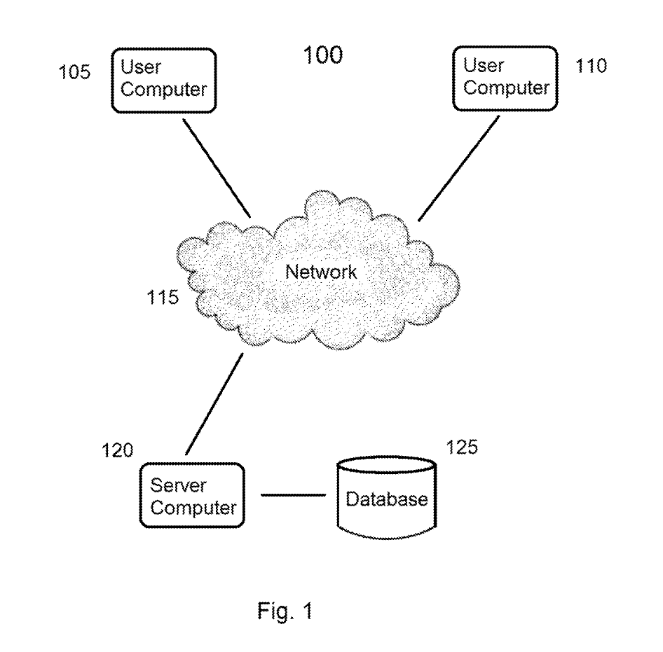

As illustrated in FIG. 1, a block diagram 100 of a general system embodiment is provided.

A typical client server system 100 configured to use points in online transactions is depicted. A user refers to any person who interacts with and uses the online marketplace website or application. Customer users access the system using computer devices 105 110. Some components of the computers include a CPU, memory (hard disk, random access memory cache memory, etc.), an OS, and network connectivity. Usable client devices 105 110 include, but are not limited to, personal computers, laptops, smart phones, tablets, connected entertainment devices (such as smart tvs), and wearable/implants (computing devices integrated with the human body but capable of displaying desktops or application windows.

The clients are configured to communicate with the server 120 across a network 115. The network 115 can be one or more wireless networks, wired network, cellular network, local area network, personal area network, Bluetooth network, a combination of networks, and/or the like. Communication can occurs directly or indirectly via one or more intermediary computer devices such as servers, relays, routers, network access points, and/or the like. This can be done from the clients 105 110 through an ASP, including social networking applications, or directly by accessing the application or website, or via an application that accesses such a website.

The server computer 120 is configured to receive calls from the client computers 105 110 and to access a database 125. Some components of the server computer 120 may include a CPU, memory (hard disk, random access memory cache memory, etc.) and network connectivity. Additionally, a database 125 may be located on the server computer 120 or the server computer 120 may have access to a database 125. Retrieval, calculations, and storage of point values are performed on the server.

Users are required to register through a user interface, via an application or website, which may require the creation of a login and password, which gives the user exclusive access to his/her personal information and account. During registration, the system checks that user's name, login, and any other identifiers are valid and unique to that user alone. A user's registration information is stored within the database. User's registration and their establishment of a history regarding past transaction in the marketplace is important.

Users regularly participate on the social network or marketplace engaging in various interactions and transactions with other users, hereinafter referred to as “transactions.” In such an online marketplace system, a user's participation can be tracked with points that are awarded to the user based on how he/she participates. These are stored in a database along with the user's registration information.

In the preferred embodiment, a user has two types of points associated with his/her profile that are used for tracking participation. One point type tracks a person's actions that involve sharing items, providing services or volunteering to other users, referred to as “share points”. These share points are awarded for the kind of actions that benefit the community. The other point type tracks a person's actions that involve borrowing items, receiving services or receiving help from other users, referred to as “borrow points”. These borrow points are awarded for the kind of actions that benefits the user. For example, in a transaction in which one user loans his/her power tool to another user, the user who owns the drill will receive share points and the borrowing user will receive borrow points. By having 2 types of points, it can be determined whether a user shares/gives to or borrows/takes more from the community. A larger number of share points indicate that a user shares more than borrows, while a larger number of borrow points indicate that a user borrows more than shares. Users can only accumulate points.

With two types of points, share and borrow, a ratio of the user's share and borrow points can be established by the system. This ratio is used to determine how many share points another user earns when interacting with a given user. By transacting with a user with a higher share to borrow ratio, a user earns more share points. Each transaction has an established point value, possibly set by the system administrator or set by a user, via a user interface, according to guidelines set by the system administrator. The ratio can be directly used to calculate how many share points a user earns from a transaction, by multiplying the ratio and the point value of the transaction. In the preferred embodiment, the ratio can also be indirectly used to calculate how many share points a user earns by using a predefined table where a share to borrow ratio is translated into a point multiplier. Alternatively a multiplier curve is applied to the ratio in order to produce a point multiplier. This value is curved with a bottom and top limit. Calculations are performed by the system, which retrieves values from the database and later stores values as well.

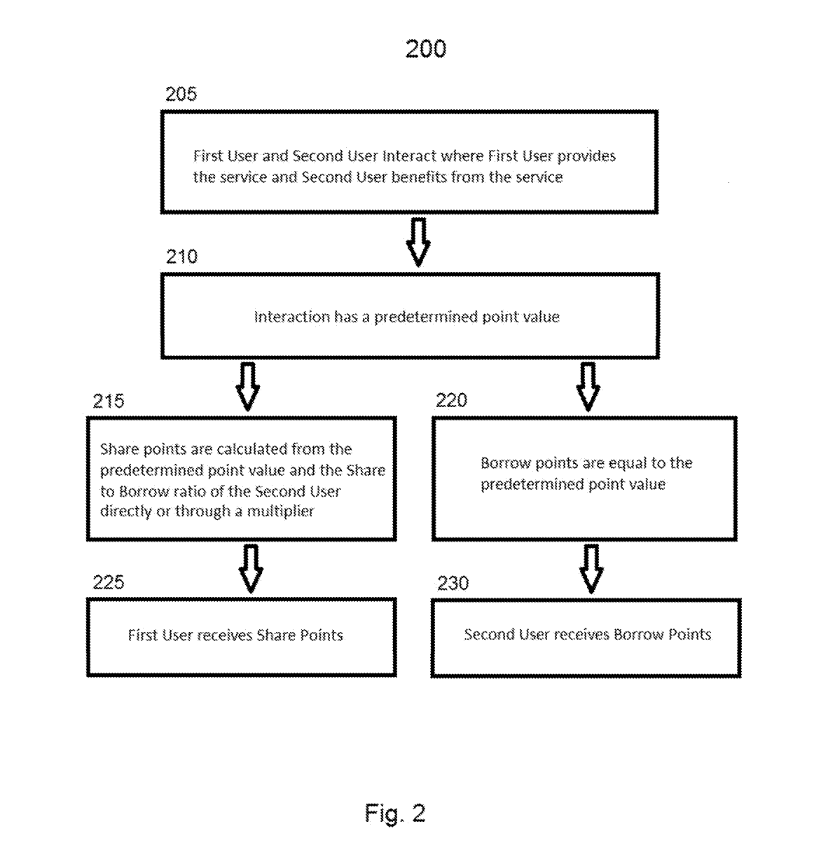

As illustrated in FIG. 2, a first user loans a power tool to a second user 205 with a share to borrow ratio of 2, as stored in the database. Using a predefined table or determined by calculating using a multiplier curve, a share to borrow ratio of 2 translates to a multiplier of 1.2. The transaction has a point value of 100 points 210, as determined by the system. The transaction borrow points will be equal to the 100 points from the transaction 220. The transaction share points can be calculated by the system processor using the multiplier of 1.2 and the predetermined point value of 100, resulting in 120 share points 215. The calculated transaction share points are added to the user's current share point total in the database 225. The transaction borrow points are added to the user's current borrow point total in the database 230. The first user will earn 1.2× the number of share points than if he had loaned the power tool to a user with a share to borrow ratio of 1. Conversely, a first user loans a power tool to a second user with a share to borrow ratio of ½. Using the predefined table, a share to borrow ratio of ½ translates to a multiplier of 0.8. The first user will earn 0.8× the number of share points than if he had loaned the power tool to a user with a share to borrow ratio of 1.

Users, who are habitual borrowers, will attain low share to borrow ratios. At some point, the ratio may become so low that other users will stop interacting with them or lending to them. Therefore, in order to remain appealing to other users, a user will need to share and participate in a way that contributes to the community. The use of the ratio between share and borrow points rewards and incentivizes users to interact and share with each other.

The system tracks a user's history using the share and borrow points. The user interface displays curved ratio of Share Vs Borrow points in a graphical representation that resembles a scale or a meter. The meter shows the user if he/she is favorable to other sharers because his/her good ratio or unfavorable because his/her ratio is poor. This is an increased knowledge and awareness of a user's own history and that of other users. When a borrower wants to borrow an item or receive a service, the sharer providing the item or service will see how many points will actually get applied.

The system is configured to allow users to create listings to offer items to other users and to request items from other users in the marketplace, via a user interface. For example, a user (sharing user) offers to loan a power tool and creates a listing. Various users (borrowing users) respond to the listing and would like to borrow the tool. Each borrowing user's curved ratio of share vs borrow points is displayed. The sharing user is able to choose which user to loan the item to, based on how many points he/she receives from the transaction.

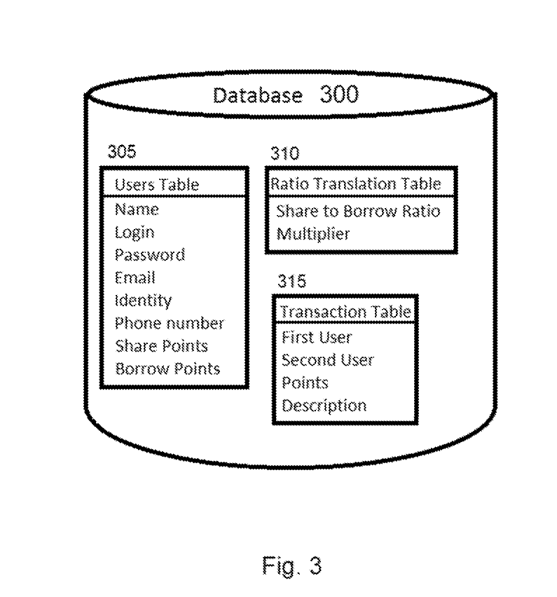

As illustrated in FIG. 3, in the preferred embodiment, database 300 consists of a Users table 305, a Ratio Translation table 310 and a Transactions table 315.

The Users table 305 stores the information of registered users, who interact and transact with other users. The table consists of the name of the user, and may include login and password information. The login and password information, if used, allows the user to securely access their information from the website or application. Additionally, the users table may include the electronic mail address, phone number, IM address, ASP identity. Lastly, the users table may contain the share points and borrow points that have been accumulated by the user.

Sample content for a row in the Users table is provided.
Name: John Smith
Login: jsmith
Password: 12345
Email: jsmith@emailme.com
Phone: 555-555-5555
Identity: jsmith@socialnetwork.com
Share Points: 2000
Borrow Points: 1000

The Ratio Translation table 310 is a table that has been prepopulated by the system. It contains specified share to borrow ratios along with point multipliers associated with those ratios. This table can be queried using the share to borrow ratio to retrieve the point multiplier.

Sample content for a row in the Plates table is provided.
Share to Borrow Ratio: 2
Point Multiplier: 1.2

The Transactions Table 315 stores all transactions and interactions between users on the system. A transaction consists of the 2 users involved in the transaction, represented by User IDs found in the Users table. The First User is the sharing user, and the Second User is the borrowing user. The table contains the base point total for the transaction, which will be used to determine how many share points and borrow points the 2 users receive from the transaction. There is a description field which provides the details of the transaction.

Using the sample content of the database, Tom Jones offers to loan his power tool with a value of 100 points. John Smith responds to the listing. The Users table can be queried where the Login is equal to jsmith to retrieve the Share Points and Borrow Points of borrower John Smith, 2000 and 1000 respectively. The Share to Borrow Ratio can be calculated as 2000 to 1000 or 2. The Ratio Translation table can be queried where the Share to Borrow Ratio is equal to 2 to retrieve the Point Multiplier, 1.2. Tom Jones is able to see that based on John Smith's history, he will receive 120 share points from the transaction. Tom Jones can see what he will receive from other users who may have respond to the listing and decide accordingly

Sample content for a row in the Transactions table is provided.
First User: tjones
Second User: jsmith
Points: 100
Description: Tom Jones is loaning his power tool to John Smith for 2 days

Using the sample content of the database, Tom Jones loans his power tool to John Smith, with a value of 100 points. The Users table can be queried where the Login is equal to jsmith to retrieve the Share Points and Borrow Points of borrower John Smith, 2000 and 1000 respectively. The Share to Borrow Ratio can be calculated as 2000 to 1000 or 2. The Ratio Translation table can be queried where the Share to Borrow Ratio is equal to 2 to retrieve the Point Multiplier, 1.2. The result of multiplying 1.2 and 100, 120, is added to Tom Jones's Share Points total. 100 points are added to John Smith's Borrow Points total.

Users can additionally earn Share Points by volunteering for various charitable organizations. The curved ratio can be skewed in a way that slowly takes sharing points out of the economy so that there are less of Share Points Vs Borrow Points. The system provides Share points to organizations that are looking for volunteers. The organizations then distribute share points to volunteers. This incentivizes charitable participation while still preventing inflation or deflation in the marketplace economy.

The preceding description contains various embodiments of the invention and no limitation of the scope is thereby intended.

That which is claimed is:

1. A computer-implemented method:
Storing, by at least one processor, a user's history of past transactions as sharing points and borrowing points;
Providing a user interface for users to create an online transaction with an established point value for the transaction, wherein the transaction involves a user sharing an item or service and another user receiving an item or service;
Adding, by at least one processor, the transaction point value to a borrowing or receiving user's borrowing points total;
Calculating, by at least one processor, a point value and adding it to a sharing or providing user's sharing points total.

2. The method of claim 1, wherein the point value added to the sharing user's sharing points total is calculated using the borrowing user's borrowing points and sharing points totals.

3. The method of claim 2, wherein the point value added to the sharing user's sharing points total is calculated by multiplying the transaction point value and the borrowing user's sharing points to borrowing points ratio.

4. The method of claim 2, wherein the point value added to the sharing user's sharing points total is calculated by translating the borrowing user's sharing points to borrowing points ratio into a point multiplier and then multiplying the transaction point value and the point multiplier.

5. A system comprising:
A database for a user's history of past transactions as sharing points and borrowing points;
A user interface for users to create an online transaction with an established point value for the transaction, wherein the transaction involves a user sharing an item or service and another user receiving an item or service;
A processor that adds the transaction point value from a borrowing or receiving user's borrowing points total and calculates and adds a point value to a sharing or providing user's sharing points total.

6. The system of claim 5, wherein the processor calculates the point value added to the sharing user's sharing points total using the borrowing user's borrowing points and sharing points totals.

7. The system of claim 6, wherein the processor calculates the point value added to the sharing user's sharing points total by multiplying the transaction point value and the borrowing user's sharing points to borrowing points ratio.

8. The system of claim 6, wherein the processor calculates the point value added to the sharing user's sharing points total by translating the borrowing user's sharing points to borrowing points ratio into a point multiplier and then multiplying the transaction point value and the point multiplier.
